(19) United States
(12) Patent Application Publication
(10) Pub. No.: US 2023/0320319 A1
(43) Pub. Date: Oct. 12, 2023

(54) Build-A-Balcony Device

(71) Applicant: Roger Vigil, Neenah, WI (US)

(72) Inventor: Roger Vigil, Neenah, WI (US)

(21) Appl. No.: 17/851,152

(22) Filed: Jun. 28, 2022

Related U.S. Application Data
(60) Provisional application No. 63/329,067, filed on Apr. 8, 2022.

(51) Int. Cl. A01K 1/035

(52) U.S. Cl. CPC A01K 1/0353

(57) ABSTRACT

The present invention relates to a novel pet bed device. The device resembles a balcony and has a set of collapsible stairs, a carpeted landing area with pockets for pet hair collection, and drawers for pet supplies. The bed can collapse into a briefcase-like structure with a handle for transportation and storage. Pet owners can expand the system and set up the adjustable rails and legs at a desire height. The balcony can be height adjustable to accommodate use in a living room, near a window, etc. Pets can walk up the stairs and enjoy relaxing or playing on the flat balcony surface while maintaining an optimal view.

### CROSS-REFERENCE TO RELATED APPLICATION

The present application claims priority to, and the benefit of, U.S. Provisional Application No. 63/329,067, which was filed on Apr. 8, 2022 and is incorporated herein by reference in its entirety.

### FIELD OF THE INVENTION

The present invention relates generally to the field of pet beds. More specifically, the present invention relates to an improved pet bed device that provides pets with a collapsible and adjustable balcony designed to offer a unique place for pets to sleep and relax. Accordingly, the present disclosure makes specific reference thereto. Nonetheless, it is to be appreciated that aspects of the present invention are also equally applicable to other like applications, devices and methods of manufacture.

### BACKGROUND

By way of background, pets, especially dogs and cats, are very popular. Many pet owners allow their dogs and/or cats to live in the house with them and will often dedicate a chair or portion of a couch to the pet. Other pet owners may not want their dogs and/or cats to climb up on furniture, such as sofas, chairs, beds, etc., due to how much damage the pet can cause with their claws. Generally, whether dedicating furniture to a pet or not allowing a pet on the furniture, a pet can cause damage to, or soiling of, the furniture. Specifically, pets can leave excess pet hair, dirt, and debris on furniture, requiring extensive cleaning of the furniture.

Often, as an alternative to dedicating some portion of a pet owner's furniture to a pet, the owner may purchase a pet bed or pet pillow and place it on the ground or on furniture to give the pet a comfortable resting place, and to prevent the pet from contacting the furniture. Although such items work well for their intended purpose, existing pet beds are bulky and often, storing the large item can be difficult. Thus, an owner may have to live around the pet bed or pillow or dedicate a significant amount of storage space during periods when it is not being used. Further, some pets may enjoy the view from a window and be unable to get up to the window with ease. Typical pet beds are not elevated for pets and are merely cushions placed on the floor.

Therefore, a novel pet bed device is needed that resembles a balcony and that is adjustable for placement near a window. Pets can utilize the device to walk up the stairs and enjoy relaxing or playing on the flat balcony surface while maintaining an optimal view.

Therefore, there exists a long-felt need in the art for a pet bed device that provides pets with a collapsible and adjustable balcony designed to offer a unique place for pets to sleep and relax. There is also a long-felt need in the art for a pet bed device that offers a way to keep pets calm and entertained while also keeping them off furniture. Further, there is a long-felt need in the art for a pet bed device that includes a drawer on the side to store pet toys and accessories, keeping them close by for playtime. Moreover, there is a long-felt need in the art for a device that collapses into a convenient carrying system when not in use, folding up into a small square for easy storage. Further, there is a long-felt need in the art for a pet bed device that allows pets to walk up the stairs to an elevated balcony that enables them to look out a window and maintain an optimal view while sitting or lying down. Finally, there is a long-felt need in the art for a pet bed device that provides a multipurpose, collapsible, and adjustable pet bed.

The subject matter disclosed and claimed herein, in one embodiment thereof, comprises a pet bed device. The device resembles a balcony and has a set of collapsible stairs, a carpeted landing area with pockets for pet hair collection, and drawers for pet supplies. The bed can collapse into a briefcase-like structure with a handle for transportation and storage. Pet owners can expand the system and set up the adjustable rails and legs at a desire height. The balcony can be height adjustable to accommodate use in a living room, near a window, etc. Pets can walk up the stairs and enjoy relaxing or playing on the flat balcony surface while maintaining an optimal view.

In this manner, the pet bed device of the present invention accomplishes all of the foregoing objectives and provides users a device with a collapsible and adjustable balcony designed to offer a unique place for pets to sleep and relax. The device collapses into a convenient carrying system when not in use, folding up into a small square for easy storage. The device comprises adjustable rails and legs to adjust the device to a desired height.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet bed device. The device resembles a balcony and has a set of collapsible stairs, a carpeted landing area with pockets for pet hair collection, and drawers for pet supplies. The bed can collapse into a briefcase-like structure with a handle for transportation and storage. Pet owners can expand the device and set up the adjustable rails and legs at a desired height, such that the balcony base component can be any suitable height as is known in the art to accommodate use in a living room, near a window, etc.

In one embodiment, the pet bed device comprises a balcony base component, comprising a flat, bottom section, configured in a square-shaped configuration. Further, any suitable shape as is known in the art, such as trapezoid, rectangular, oval, etc., can be utilized depending on the needs and/or wants of a user. The balcony base component further comprises four legs each positioned at a corner of the balcony base component, so as to elevate the balcony base component above the floor of the room in which it is sitting. Such legs could be solid and extend around the entire periphery of the balcony base component, provided the balcony base component is elevated above the floor of the room upon which it rests. Further, the legs can be slender rod-like structures, with one leg being positioned in each corner of the base component, to support the base component off of the floor. The legs can be secured to the base component in any suitable manner as is known in the art, such as gluing, screws, bolts, etc.

In one embodiment, the height of the pet bed device shown is of the conventional height of a standard coffee table, wherein the balcony base component is elevated above the floor of the room in which it is present. Typically, the legs are adjustable to allow for the balcony base component to be raised or lowered to a desired height. For example, if the pet desires to look out a window or if the pet desires to be as high as the couch, etc., the legs can adjusted allowing the balcony base to be raised or lowered. Generally, the legs are telescoping with a spring button/plunger for securing the legs at a desired height. However, any other suitable adjusting means can be utilized as is known in the art.

In another embodiment, the end of each leg comprises a caster or wheel with a brake, which allows for movement of the pet bed device. The wheels allow a user to push the device in a desired position within a room. Any suitable wheels or casters (including those with brakes) can be utilized as is known in the art, and the wheels can be secured to the legs by any known means.

In yet another embodiment, the balcony base component comprises a railing along the perimeter of the base component. The railing encloses the flat, bottom section of the base component, and can be any suitable height as is known in the art, depending on the needs and/or wants of a user. The railing can be adjustable to a desired height. Typically, the railing, as with the legs, is telescoping with a spring button/plunger for securing the railing at a desired height.

In one embodiment, the balcony base component comprises a drawer. Specifically, at one end or side of the base component is provided at least one drawer with a handle to enable it to be readily withdrawn from the base component. The at least one drawer is for storing pet supplies and/or toys, keeping the supplies and/or toys close-by for playtime. Any suitable number of drawers can be utilized as is known in the art, depending on the needs and/or wants of a user. Further, the drawers can be positioned in any suitable position along the size of the base component. The portion of the base component over the drawer is the flat, bottom section.

In another embodiment, the balcony base component comprises a hinged staircase and/or ramp for entering the device, or any other suitable means for entering as is known in the art. The ramp can be any suitable size and shape as is known in the art, depending on the needs and/or wants of a user. The ramp comprises hinges at a top end, securing the ramp to the balcony base component, and allowing the ramp to fold up and rest flat against the flat, bottom section of the base component. The hinges can comprise any suitable hinges as is known in the art, such as living hinges, mechanical hinges, etc. Specifically, when the hinged ramp is rotated to an open position, it is held in an extended manner via the hinge and forms a ramp which contacts the floor at an acute angle permitting the pet to walk up the ramp and jump into the pet bed device, where it may rest, look out the window, or otherwise enjoy itself. Typically, the ramp is provided with a series of steps, notches, cleats or anti-slip means to make it easier for the pet to climb the ramp. Further, in a closed position, the ramp is lowered onto the flat, bottom section of the base component and held in an extended manner via the hinge. When it is extended to the open position, a latch (not shown) holds it in that position until released.

In one embodiment, the ramp is replaced with a set of stairs. The set of stairs are releasably connected to the base component and can be rotated up and down as the ramp is, or can be, completely removed from the base component and stored when not in use.

In another embodiment, the balcony base component and the ramp/stairs can be carpeted with any suitable material as is known in the art depending on the needs and/or wants of a user. In yet another embodiment, the carpeted base component comprises a plurality of pockets for pet hair collection. The plurality of pockets can be positioned on any suitable place that is carpeted, such as the base component, the ramp, and/or the stairs. The plurality of pockets act to collect pet hair either via a user sweeping the pet hair into the pockets and/or via a pet rubbing against the pockets. The plurality of pockets can be emptied later, depending on the needs and/or wants of a user. The plurality of pockets can collect pet hair in any suitable means as is known in the art.

Additionally, in one embodiment, a user can position additional bedding on the carpeted base component. For example, any suitable bedding material as is known in the art, which usually consists merely of a thin flat pillow or pad, can be utilized depending on the needs and/or wants of a user.

In yet another embodiment, the pet bed device can be collapsed into a flat, briefcase-like structure for storage and transportation. Specifically, the legs can be hinged, such that the legs fold inward and rest against a bottom of the base component. Further, the ramp is also hinged, and folds upward and over to rest against a top of the base component. The legs and ramp can be secured in place via a latch (not shown), or any other suitable securing means as is known in the art. If a staircase is used instead of a ramp, the staircase would be detached from the base component and stored separately. In one embodiment, the device also comprises at least one handle, but preferably two handles positioned on the sides of the base component for transporting the device once in a collapsed position. The handles can be secured to the base component via any suitable securing means as is known in the art.

In another embodiment, the pet bed device comprises a plurality of indicia on the base component.

In yet another embodiment, the pet bed device and its components are manufactured from furniture-like materials, such as wood, metal, plastics or polymers, such as polypropylene or acrylonitrile-butadiene-styrene (ABS), polycarbonate, polyethylene, fiberglass, etc., or any other suitable materials as is known in the art.

In yet another embodiment, the pet bed device is manufactured from a material that is water resistant.

In yet another embodiment, a method of utilizing a pet bed device comprising a collapsible and adjustable balcony is disclosed. The method includes the steps of providing a pet bed device that is multipurpose. The method also comprises adjusting the height of the legs and/or rails to a predetermined height, such that pets maintain an optimal view even when laying on the balcony surface. Further, the method comprises applying carpet to the stairs and/or balcony before use. The method comprises, allowing pets to walk up the stairs and enjoy relaxing or playing on the balcony surface. Finally, once done, collapsing the device for easy transportation and storage.

In yet another embodiment of the present invention, a pet bed device is disclosed for providing pets with a collapsible and adjustable balcony designed to offer a unique place for pets to sleep and relax. The device resembles a balcony and has a set of collapsible stairs, a carpeted landing area with pockets for pet hair collection, and drawers for pet supplies. The bed can collapse into a briefcase-like structure with a handle for transportation and storage. Pet owners can expand the system and set up the adjustable rails and legs at a desire height. The balcony can be height adjustable to accommodate use in a living room, near a window, etc. Pets can walk up the stairs and enjoy relaxing or playing on the flat balcony surface while maintaining an optimal view.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pet bed device of the present invention, wherein a pet is utilizing the stairs in accordance with the disclosed architecture;

FIG. 2 illustrates a perspective view of another potential embodiment of the pet bed device of the present invention showing how the height may be adjusted and carpet added in accordance with the disclosed architecture;

FIG. 3 illustrates a perspective view of another potential embodiment of the pet bed device of the present invention showing how toys are stored in a drawer of the device in accordance with the disclosed architecture;

FIG. 4 illustrates a perspective view showing how one potential embodiment of the pet bed device may be collapsed for storage in accordance with the disclosed architecture;

FIG. 5 illustrates a perspective view of one potential embodiment of the pet bed device of the present invention in use in accordance with the disclosed architecture; and

FIG. 6 illustrates a flowchart showing the method of utilizing one potential embodiment of the pet bed device of the present invention, wherein the device is comprised of a collapsible and adjustable balcony in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet bed device that provides pets with a collapsible and adjustable balcony designed to offer a unique place for pets to sleep and relax. There is also a long-felt need in the art for a pet bed device that offers a way to keep pets calm and entertained while also keeping them off furniture. Further, there is a long-felt need in the art for a pet bed device that includes a drawer on the side to store pet toys and accessories, keeping them close by for playtime. Moreover, there is a long-felt need in the art for a device that collapses into a convenient carrying system when not in use, folding up into a small square for easy storage. Further, there is a long-felt need in the art for a pet bed device that allows pets to walk up the stairs to an elevated balcony that enables them to look out a window and maintain an optimal view while sitting or lying down. Finally, there is a long-felt need in the art for a pet bed device that provides a multipurpose, collapsible, and adjustable pet bed.

The present invention, in one exemplary embodiment, is a novel pet bed device that is a multipurpose, collapsible, and adjustable pet bed. The device resembles a balcony and has a set of collapsible stairs, a carpeted landing area with pockets for pet hair collection, and drawers for pet supplies. The bed can collapse into a briefcase-like structure with a handle for transportation and storage. Pet owners can expand the system and set up the adjustable rails and legs at a desire height. The balcony can be height adjustable to accommodate use in a living room, near a window, etc. The present invention also includes a novel method of utilizing a pet bed device comprising a collapsible and adjustable balcony. The method includes the steps of providing a pet bed device that is multipurpose. The method also comprises adjusting the height of the legs and/or rails to a predetermined height, such that pets maintain an optimal view even when laying on the balcony surface. Further, the method comprises applying carpet to the stairs and/or balcony before use. The method comprises, allowing pets to walk up the stairs and enjoy relaxing or playing on the balcony surface. Finally, once done, collapsing the device for easy transportation and storage.

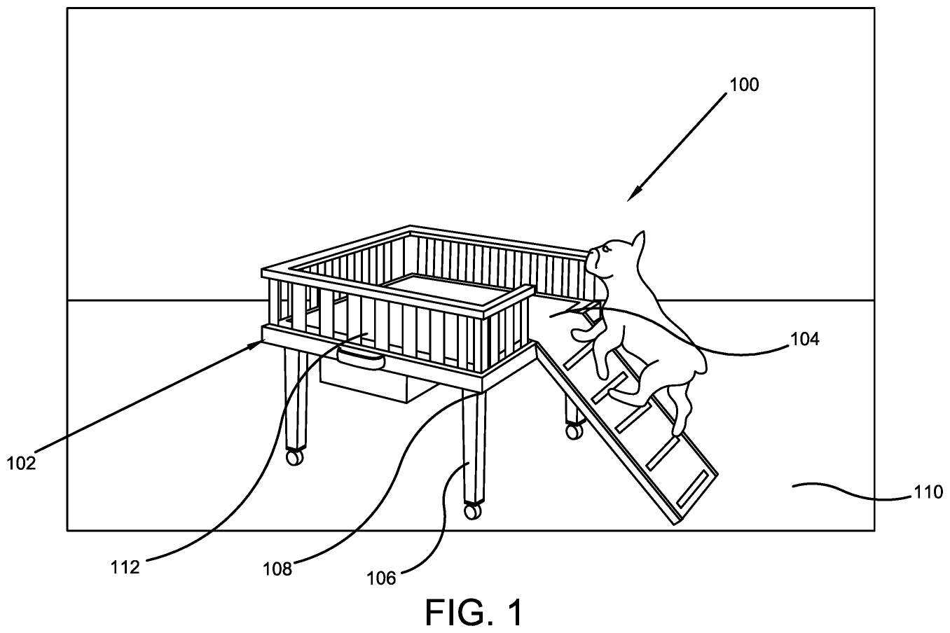

Referring initially to the drawings, FIG. 1 illustrates a perspective view of one embodiment of the pet bed device 100 of the present invention. In the present embodiment, the pet bed device 100 is an improved pet bed device that comprises a collapsible and adjustable balcony designed to offer a unique place for pets to sleep and relax. The device 100 is especially designed to allow a pet, such as a dog, a cat, etc., or any other suitable user as is known in the art, to walk up the stairs and enjoy relaxing or playing on the balcony. More specifically, the device 100 comprises a balcony base component 102, comprising a flat, bottom section 104, configured in a square-shaped configuration. Further, any suitable shape as is known in the art, such as trapezoid, rectangular, oval, etc., can be utilized depending on the needs and/or wants of a user.

The balcony base component 102 further comprises four legs 106 each positioned at a corner 108 of the balcony base component 102, so as to elevate the balcony base component 102 above the floor 110 of the room in which it is sitting. Such legs 106 could be solid and extend around the entire periphery of the balcony base component 102 provided the balcony base component 102 is elevated above the floor 110 of the room upon which it rests. Further, the legs 106 can be slender rod-like structures, with one leg 106 being positioned in each corner 108 of the base component 102, to support the base component 102 off the floor 110. The legs 106 can be secured to the base component 102 by any suitable manner as is known in the art, such as gluing, screws, bolts, etc., depending on the needs and/or wants of a user.

Furthermore, the balcony base component 102 comprises a railing 112 along the perimeter of the base component 102. The railing 112 encloses the flat, bottom section 104 of the base component 102 and can be any suitable height as is known in the art, depending on the needs and/or wants of a user. The railing 112 can be adjustable to a desired height. Typically, the railing 112 is telescoping with a spring button/plunger (not shown) for securing the railing 112 at a desired height, but any suitable adjustable means can be used as is known in the art, depending on the needs and/or wants of a user. In one embodiment, the railing 112 is not adjustable and the height of the balcony base component 102 can be varied based solely on the telescoping legs 106.

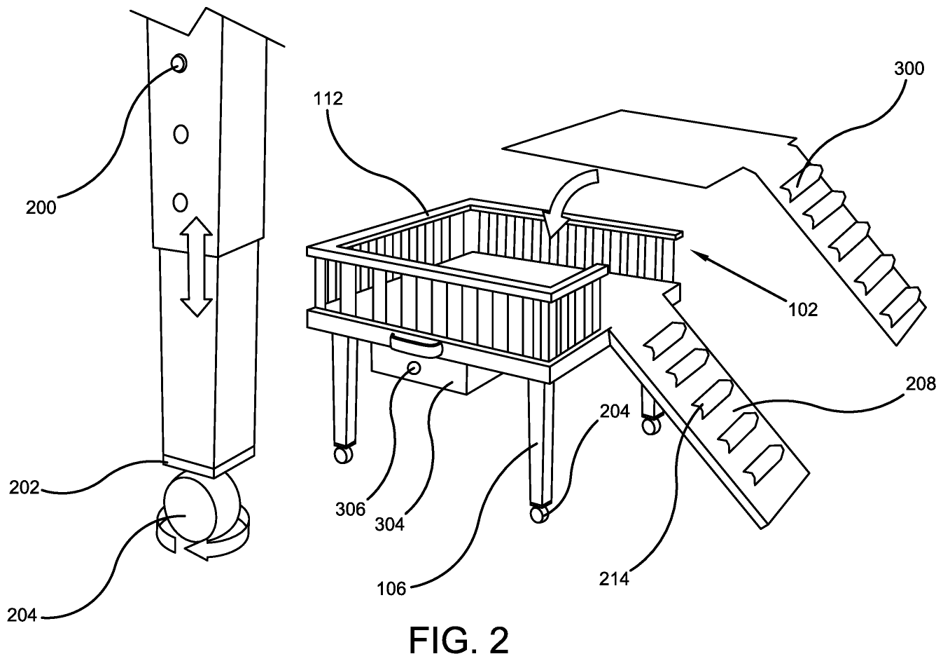

FIG. 2 illustrates a perspective view of another embodiment of the pet bed device 100 of the present invention, disclosing the telescoping legs 106. In this embodiment, the height of the pet bed device 100 shown is of the conventional height of a standard coffee table, wherein the balcony base component 102 is elevated above the floor 110 of the room in which it is present. Typically, the legs 106 are adjustable to allow for the balcony base component 102 to be raised or lowered to a desired height. For example, if the pet desires to look out a window or if the pet desires to be as high as the couch, etc., the legs 106 can be adjusted, allowing the balcony base 102 to be raised or lowered. Generally, the legs 106 are telescoping with a spring button/plunger 200 for securing the legs 106 at a desired height. However, any other suitable adjusting means can be utilized as is known in the art, depending on the needs and/or wants of a user.

In another embodiment, the end 202 of each leg 106 comprises a caster or wheel 204, which allows for movement of the pet bed device 100. The wheels 204 allow a user to push the device 100 in a desire position within a room. Further, the wheels 204 allow for ease in movement, requiring only one user to push and/or pull the device 100 into position. Any suitable wheels 204 or casters can be utilized as is known in the art (including those with brakes), and the wheels 204 can be secured to the legs 106 by any known means.

Furthermore, the balcony base component 102 comprises a hinged staircase 206 and/or ramp 208 for entering the device 100, or any other suitable means for entering as is known in the art. The ramp 208 can be any suitable size and shape as is known in the art, depending on the needs and/or wants of a user. The ramp 208 comprises hinges 210 at a top end 212, securing the ramp 208 to the balcony base component 102, and allowing the ramp 208 to fold up and rest flat against the flat, bottom section 104 of the base component 102. The hinges 210 can comprise any suitable hinges as is known in the art, such as living hinges, mechanical hinges, etc. Specifically, when the hinged ramp 208 is rotated to an open position, it is held in an extended manner via the hinge 210 and forms a ramp 208 which contacts the floor at an acute angle permitting the pet to walk up the ramp 208 and jump into the pet bed device 100, where it may rest, look out the window, or otherwise enjoy itself. Typically, the ramp 208 is provided with a series of steps, notches, cleats or anti-slip means 214 to make it easier for the pet to climb the ramp 208. Further, in a closed position, the ramp 208 is lowered onto the flat, bottom section 104 of the base component 102 and held in an extended manner via the hinge 210. When it is extended to the open position, a latch (not shown) holds it in that position until released.

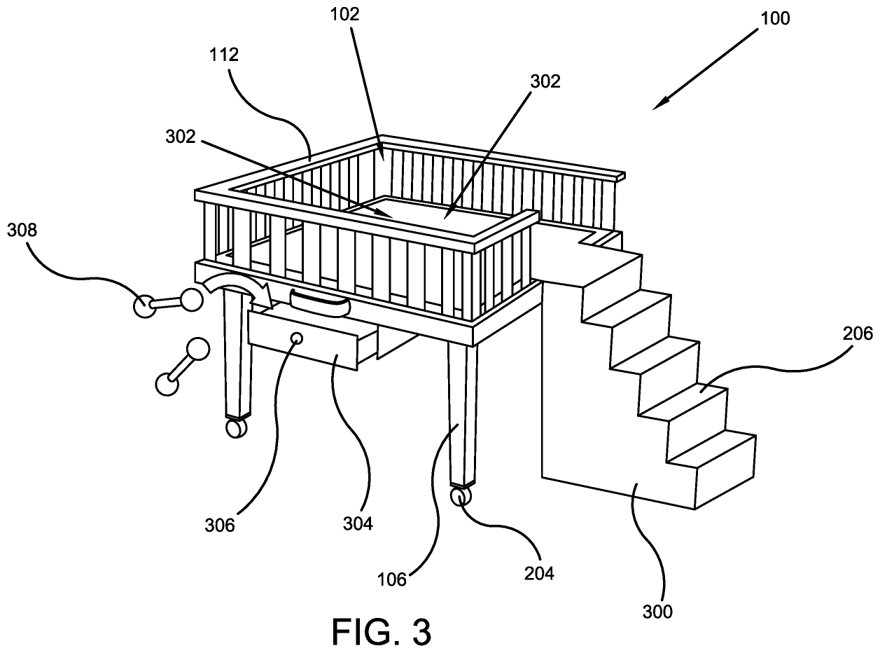

FIG. 3 illustrates a perspective view of another embodiment of the pet bed device 100 of the present invention, further disclosing a set of stairs 206. In this embodiment, the ramp 208 is replaced with a set of stairs 206. The set of stairs 206 are releasably connected to the base component 102 and can be rotated up and down as the ramp 208 is, or can be, detached and completely removed from the base component 102 and stored when not in use.

Further, the balcony base component 102 and the ramp 208/stairs 206 can be carpeted 300 with any suitable material as is known in the art, depending on the needs and/or wants of a user, such as fabric, polyester, cotton, etc. In yet another embodiment, the carpeted base component 102 comprises a plurality of pockets 302 for pet hair collection. The plurality of pockets 302 can be positioned on any suitable place that is carpeted 300, such as the base component 102, the ramp 208, and/or the stairs 206. The plurality of pockets 302 act to collect pet hair either via a user sweeping the pet hair into the pockets 302 and/or via a pet rubbing against the pockets 302. The plurality of pockets 302 can be emptied later depending on the needs and/or wants of a user. The plurality of pockets 302 can collect pet hair in any suitable means as is known in the art.

Additionally, in one embodiment, a user can position additional bedding (not shown) on the carpeted base component 102. For example, any suitable bedding material as is known in the art, which usually consists merely of a thin flat pillow or pad, can be utilized depending on the needs and/or wants of a user.

Furthermore, the balcony base component 102 comprises a drawer 304. Specifically, at one end or side of the base component 102, at least one drawer 304 with a handle 306 to enable it to be readily withdrawn from the base component 102 is provided. The at least one drawer 304 is for storing pet supplies and/or toys 308, keeping the supplies and/or toys 308 close-by for playtime. Any suitable number of drawers 304 can be utilized as is known in the art, depending on the needs and/or wants of a user. Further, the drawers 304 can be positioned in any suitable position along the side of the base component 102. The portion of the base component 102 over the drawer 304 is the flat, bottom section 104.

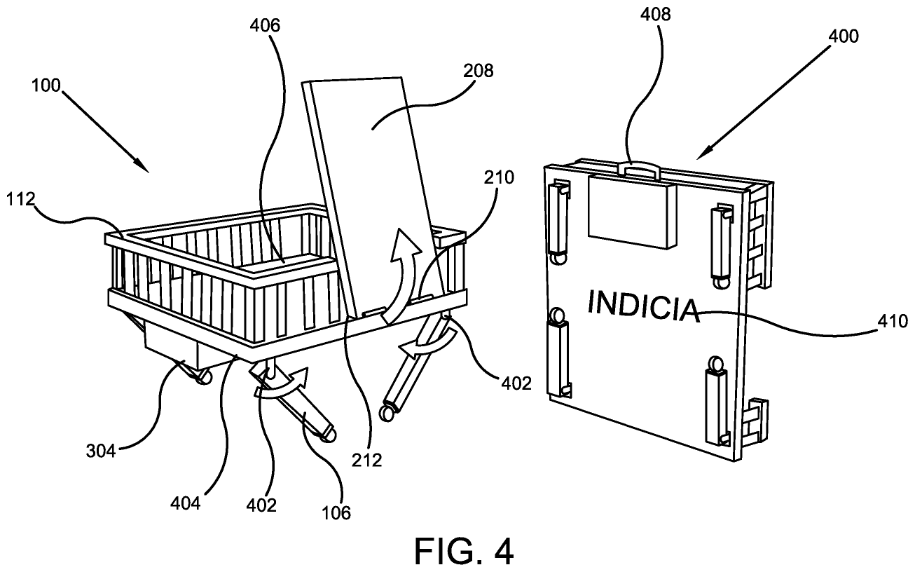

FIG. 4 illustrates a perspective view of another embodiment of the pet bed device 100 of the present invention, collapsed for storage. In this embodiment, the pet bed device 100 can be collapsed into a flat, briefcase-like structure 400 for storage and transportation. Specifically, the legs 106 can be hinged 402, such that the legs 106 fold inward and rest against a bottom 404 of the base component 102. Further, the ramp 208 is also hinged 210 and folds upward and over to rest against a top 406 of the base component 102. The legs 106 and ramp 208 can be secured in place via a latch (not shown), or any other suitable securing means as is known in the art. If a staircase 206 is used instead of a ramp 208, the staircase 206 would be detached from the base component 102 and stored separately. In one embodiment, the device 100 also comprises at least one handle 408, but preferably two handles 408 are positioned on the sides of the base component 102 for transporting the device 100 once in a collapsed position. The handles 408 can be secured to the base component 102 via any suitable securing means as is known in the art, such as gluing, screws, bolts, etc.

In another embodiment, the pet bed device 100 comprises a plurality of indicia 410 on the base component 102. The base component 102 of the pet bed device 100 may include advertising, a trademark, or other letters, designs, or characters, printed, painted, stamped, or integrated into the base component 102, or any other indicia 410 as is known in the art. Specifically, any suitable indicia 410 as is known in the art can be included, such as but not limited to, patterns, logos, emblems, images, symbols, designs, letters, words, characters, animals, advertisements, brands, etc., that may or may not be pet or brand related.

In yet another embodiment, the pet bed device 100 and its components is manufactured from furniture-like materials, such as wood, metal, plastics or polymers, such as polypropylene or acrylonitrile-butadiene-styrene (ABS), polycarbonate, polyethylene, polyethylene terephthalate, polyvinyl chloride, polystyrene, polylactic acid, etc., or any other suitable materials as is known in the art. Generally, the pet bed device 100 is also manufactured from a material that is water resistant or water permeable, or the balcony base component 102 comprises a coating that is water resistant or water permeable.

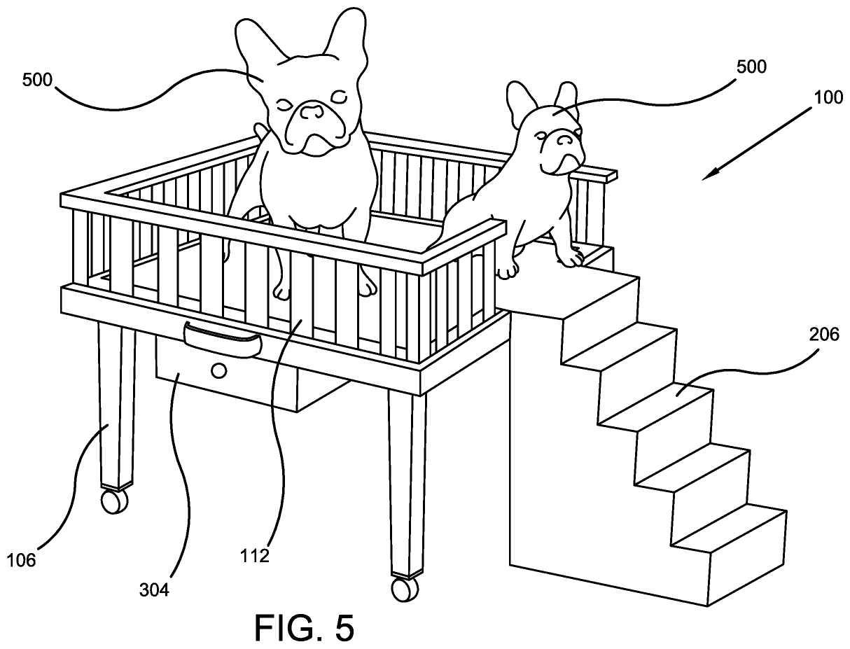

FIG. 5 illustrates a perspective view of another embodiment of the pet bed device 100 of the present invention in use. A pet bed device 100 is disclosed for providing pets 500 with a collapsible and adjustable balcony component 102 designed to offer a unique place for pets 500 to sleep and relax. The device 100 comprises a balcony base component 102 and has a set of collapsible stairs 206 or ramp 208, a carpeted 300 landing area (or bottom section) 104 with pockets 302 for pet hair collection, and drawers 304 for pet supplies 308. The pet bed device 100 can collapse into a briefcase-like structure 400 with a handle 408 for transportation and storage. Pet owners can expand the device 100 and set up the adjustable rails 112 and legs 106 at a desired height. The balcony base component 102 can be height adjustable to accommodate use in a living room, near a window, etc. Pets 500 can walk up the stairs 206/ramp 208 and enjoy relaxing or playing on the flat balcony base component 102 while maintaining an optimal view.

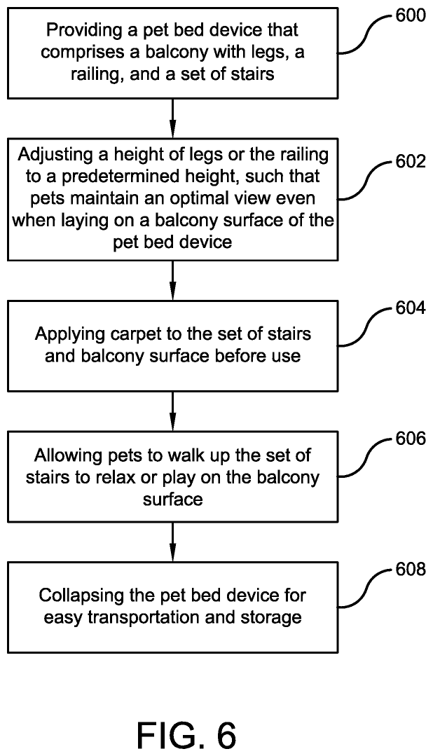

FIG. 6 illustrates a flowchart of the method of utilizing a pet bed device comprising a collapsible and adjustable balcony. The method includes the steps of at 600, providing a pet bed device that is multipurpose. The method also comprises at 602, adjusting a height of the legs and/or rails to a predetermined height, such that pets maintain an optimal view even when laying on the balcony surface. Further, the method comprises at 604, applying carpet to the stairs and/or balcony before use. The method comprises at 606, allowing pets to walk up the stairs to relax and/or play on the balcony surface. Finally, once done at 608, collapsing the device for easy transportation and storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet bed device” and “device” are interchangeable and refer to the pet bed device 100 of the present invention.

Notwithstanding the foregoing, the pet bed device 100 of the present invention can be of any suitable size and configuration as is known in the art without affecting the overall concept of the invention, provided that it accomplishes the above-stated objectives. One of ordinary skill in the art will appreciate that the pet bed device 100 as shown in FIGS. 1-6 is for illustrative purposes only, and that many other sizes and shapes of the pet bed device 100 are well within the scope of the present disclosure. Although the dimensions of the pet bed device 100 are important design parameters for user convenience, the pet bed device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet bed device that offers a pet a way to remain calm and entertained while also keeping the pet off of an article of furniture, the pet bed device comprising:
a balcony base component comprising a bottom section, a plurality of legs secured to a bottom perimeter of the balcony base component, and a railing secured to a top perimeter of the balcony base component; and
a ramp secured to the balcony base component to allow the pet to climb up the ramp and enter the balcony base component, wherein the plurality of legs act to elevate the balcony base component above a floor surface.

2. The pet bed device of claim 1, wherein the bottom section is configured in a square-shaped configuration.

3. The pet bed device of claim 1, wherein the plurality of legs are comprised of four legs and each of the four legs is secured to a corner of the balcony base component.

4. The pet bed device of claim 3, wherein the four legs are telescoping to allow the balcony base component to be raised or lowered relative to the floor surface.

5. The pet bed device of claim 4, wherein each of the four legs comprise a spring button for securing the four legs at a desired height above the floor surface, and a wheel.

6. The pet bed device of claim 1 further comprising a set of stairs.

7. The pet bed device of claim 1 wherein the ramp comprises a series of steps to allow for ease in walking on the ramp.

8. The pet bed device of claim 1, wherein each of the ramp and the balcony base component is carpeted.

9. The pet bed device of claim 8, wherein the carpeted balcony base component comprises a plurality of pockets.

10. The pet bed device of claim 1, wherein the balcony base component comprises at least one drawer.

11. The pet bed device of claim 1, wherein the pet bed device is collapsible for easy storage and transportation.

12. The pet bed device of claim 11, wherein each of the plurality of legs comprises at least one hinge and is foldable inward against the balcony base component.

13. The pet bed device of claim 12, wherein the ramp comprises a plurality of hinges and is folded upward and over to rest against the balcony base component.

14. The pet bed device of claim 13, wherein the balcony base component comprises a handle for transportation once collapsed.

15. A pet bed device that offers a pet a way to keep calm and entertained while also keeping the pet off of an article of furniture, the pet bed device comprising:
a balcony base component comprising a bottom section, a drawer, a set of four telescoping legs wherein each of the set of four telescoping legs is secured to a bottom corner of the balcony base component, and a railing secured to a top perimeter of the balcony base component;
wherein the set of four telescoping legs act to elevate the balcony base component above a floor surface;
wherein each of the set of four telescoping legs comprise a spring button for securing the set of four telescoping legs at a desired length; and
wherein a set of stairs is secured to the balcony base component to allow the pet to climb up the set of stairs and enter the balcony base component.

16. A pet bed device of claim 15 further comprising a plurality of indicia.

17. The pet bed device of claim 15, wherein the pet bed device can be collapsed for storage and transportation via the set of four telescoping legs folding inward against the balcony base component.

18. The pet bed device of claim 15 further comprising a carpeting attached to each of the set of stairs and the balcony base component.

19. The pet bed device of claim 18, wherein the carpeted balcony base component comprises a plurality of pockets.

20. A method of utilizing a pet bed device comprising a collapsible and adjustable balcony, the method comprising the steps of:
providing the pet bed device with the collapsible and adjustable balcony, a plurality of legs, a railing, and a set of stairs;
adjusting a length of the plurality of legs or the railing to a predetermined length, such that a pet maintains an optimal view even when laying on a balcony surface of the pet bed device;
applying a carpet to the set of stairs and the balcony surface before use;
allowing the pet to walk up the set of stairs to relax or play on the balcony surface; and
collapsing the pet bed device for easy transportation and storage when not in use.
